(19) United States
(12) Patent Application Publication
(10) Pub. No.: US 2006/0161979 A1
(43) Pub. Date: Jul. 20, 2006

(54) Scriptable emergency threat communication and mitigating actions

(75) Inventors: Ganesh Pandey, Kirkland, WA (US); Debi P. Mishra, Bellevue, WA (US); Brian Richard Hall, Seattle, WA (US); John L. Schacher, Bellevue, WA (US); Mark D. Zuber, Duvall, WA (US); Salim Chawro, Sammamish, WA (US)

Correspondence Address: LAW OFFICES OF ALBERT S. MICHALIK;C/O MICROSOFT CORPORATION, 704 - 228TH AVENUE NE, SUITE 193, SAMMAMISH, WA, 98074, US

(73) Assignee: Microsoft Corporation, Redmond (US)

(21) Appl. No.: 11/039,672

(22) Filed: Jan. 18, 2005

(51) Int. Cl. G06F 12/14

(52) U.S. Cl. 726/22

(57) ABSTRACT

A method and system for communicating emergency information about computer security threats together with mitigating actions that may be performed depending on the configuration of each computer. A secure package that includes a message regarding a threat and that potentially includes a script including actions to mitigate the threat is created. The secure package is published to make it available for downloading. The alert package is downloaded by a set of computers, and the message and the script (if any) are extracted. Stats and other feedback from the computers that download the alert package may be provided.

### FIELD OF THE INVENTION

The invention relates generally to computers, and more particularly to security.

### BACKGROUND

Computer security threats are becoming an almost everyday occurrence. Sometimes a vulnerability is discovered by a computer hacker and exploited before a patch is available that addresses the vulnerability. At other times, a virus or the like is created after a vulnerability has been announced and a patch made available. Some viruses may cause little or no damage while others may cause tremendous damage in information lost, productivity disruption, rebuilding efforts, and otherwise. Viruses may rapidly spread from one computer to another and may quickly cause damage on infected computers.

What is needed is a method and system for quickly communicating emergency information about computer security threats and providing mitigating actions that may be performed to address the threats. Ideally, such a method and system could adapt its information and actions based on the configuration of each computer to which the information was transmitted.

### SUMMARY

Briefly, the present invention provides a method and system for communicating emergency information about computer security threats together with mitigating actions that may be performed depending on the configuration of each computer. A secure package that includes a message regarding a threat and that potentially includes a script including actions to mitigate the threat is created. The secure package is published to make it available for downloading. The alert package is downloaded by targeted computers, and checked for integrity. The message and the script (if any) are extracted. The targeted computers may provide stats and other feedback after downloading the package.

In one aspect, an enterprise server downloads the secure package and creates another secure package based thereon to distribute to computers within the enterprise. The enterprise server may select these computers based on policy.

In another aspect, the secure package is broadcast to targeted computers in a simulated broadcast. The term simulated broadcast refers to the secure package being distributed by making the secure package available on one or more servers and having targeted computers periodically check the one or more servers and download the secure package when it becomes available. This effectively broadcasts the secure package to the targeted computers even though it is the targeted computers that are checking for and downloading the secure package rather than the server computers that are pushing the secure package to the targeted computers.

In another aspect, each target computer includes code that enables it to parse the secure package, apply the conditions included in the secure package to determine if the secure package applies to the target computer, and run scripts (if any) that are included in the secure package.

Other aspects will become apparent from the following detailed description when taken in conjunction with the drawings, in which:

### BRIEF DESCRIPTION OF THE DRAWINGS

FIG. 1 is a block diagram representing a computer system into which the present invention may be incorporated;

FIG. 2 is a block diagram representing an exemplary environment in which the present invention may operate in accordance with various aspects of the invention;

FIG. 3 is a block diagram representing an exemplary arrangement of components of a computer in which the present invention may operate in accordance with various aspects of the invention;

FIG. 4 is a flow diagram that generally represents actions that may occur on an alert publisher in accordance with various aspects of the invention;

FIG. 5 is a flow diagram that generally represents actions that may occur on a computer that is interested in alerts in accordance with various aspects of the invention;

FIG. 6 is a flow diagram that generally represents actions that correspond to block 540 of FIG. 6 that may occur when a script included in an alert package is executed in accordance with various aspects of the invention; and

FIG. 7 shows a window that includes an exemplary message that may be displayed in response to an alert in accordance with various aspects of the invention.

### DETAILED DESCRIPTION

Exemplary Operating Environment

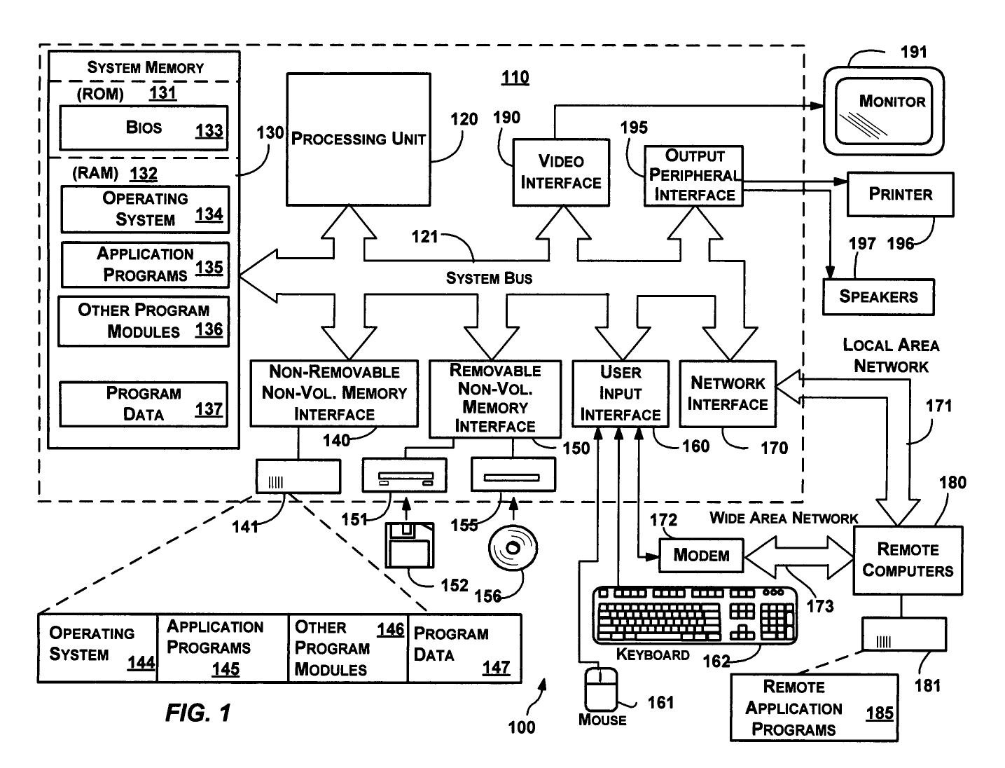

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Emergency Security Alerts

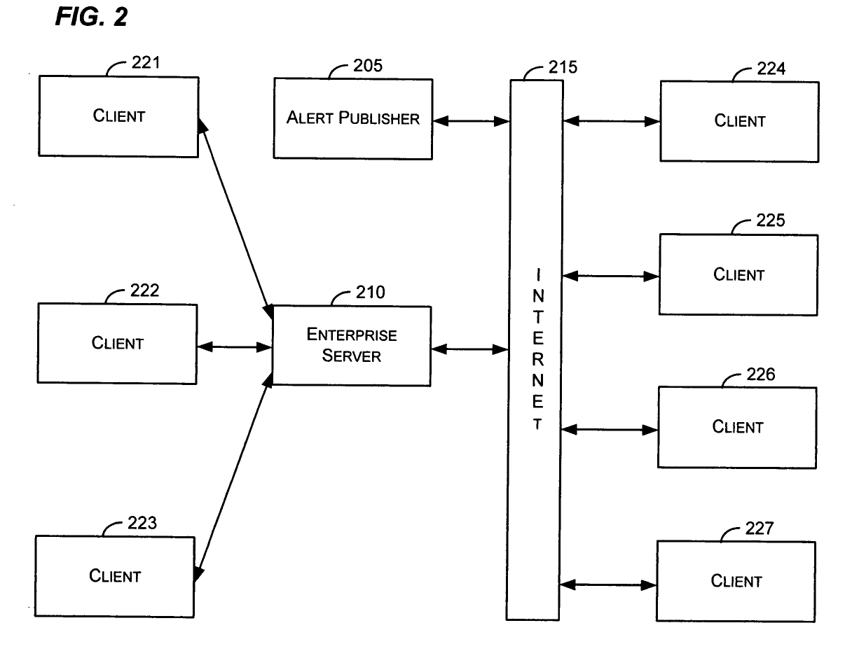

FIG. 2 is a block diagram representing an exemplary environment in which the present invention may operate in accordance with various aspects of the invention. The environment includes an alert publisher 205, an enterprise server 210, and clients 221-227 and may include other entities (not shown). The various entities may communicate with each other via various networks including intra-networks and the Internet 215.

After a security threat is identified, an alert package may be created. An alert package may include a message to display to users and a script. The message may include information about a threat and may indicate actions which a user may take to protect against the threat. The script may include checks which determine whether the particular computer upon which the script is executing is vulnerable to the threat. If the computer is not vulnerable, the script may modify the message, for example, to indicate that the threat exists but that the computer is not vulnerable to the threat.

Alternatively, the script may prevent any message from being displayed if the computer is not vulnerable. For example, if a Web server component is available on a set of machines but is only utilized on a subset of those machines, the machines upon which the Web server component is available but not utilized may or may not receive a message indicating that the Web server component has a vulnerability.

If the computer is vulnerable, the script may perform mitigating actions automatically (e.g., without user involvement) or may require user interaction before performing any mitigating actions. An option to undo mitigating actions may also be provided. The message may include a link which, when selected, may cause the mitigating actions of the script to be performed.

Mitigating actions may include, for example, blocking a port, preventing an application from running, restoring a previous state of a system (e.g., to before a patch was applied that made the system vulnerable), and the like. In general, mitigating actions may comprise any actions that may be performed by a kernel-mode or user-mode process and may vary depending on the threat.

After an alert package is created, the alert package may then be published (e.g., made available) via an alert publisher 205. The alert publisher 205 may comprise one or more servers located at one or more locations from which the alert package may be obtained. Periodically, computers that are monitoring for new alert packages (e.g., clients 224-227 and enterprise server 210) may poll the alert publisher to determine if a new alert package is available. This monitoring may be performed via an automatic update component that executes on each of the computers.

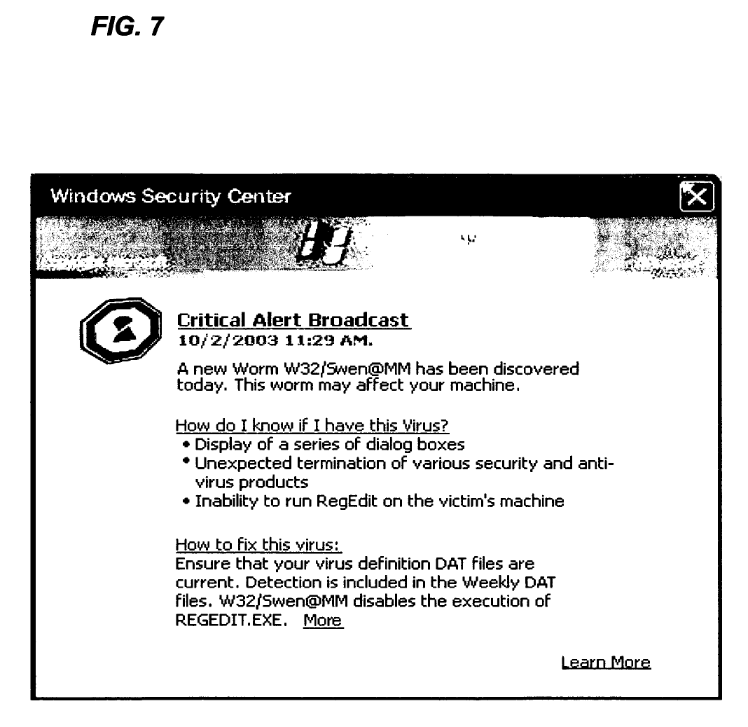

After a computer determines that a new alert package is available, the computer may then download the alert package and provide a visual indication that a new alert has been received. An exemplary visual indication is shown in FIG. 7. If more than one new alert package is available, the computer may download all new alert packages. Making the alert package available on the alert publisher 205 and checking for new alert packages and downloading them as they become available by clients 224-227 and enterprise server 210 essentially broadcasts the alert package.

The enterprise server 210 may also poll for new alert packages and may download new alert packages as they become available. The enterprise server 210 may then modify the alert package to suit the requirements of a particular enterprise. Then, the enterprise server 210 may propagate the modified alert package to computers of the enterprise based on policy. These computers may include one or more of clients 221-227.

An alert package may be secured to ensure that the alert package may not be modified by unauthorized entities without detection. In one embodiment, the alert package is digitally signed for security. It will be recognized, however, that the alert package may be secured in a variety of ways without departing from the spirit or scope of the present invention.

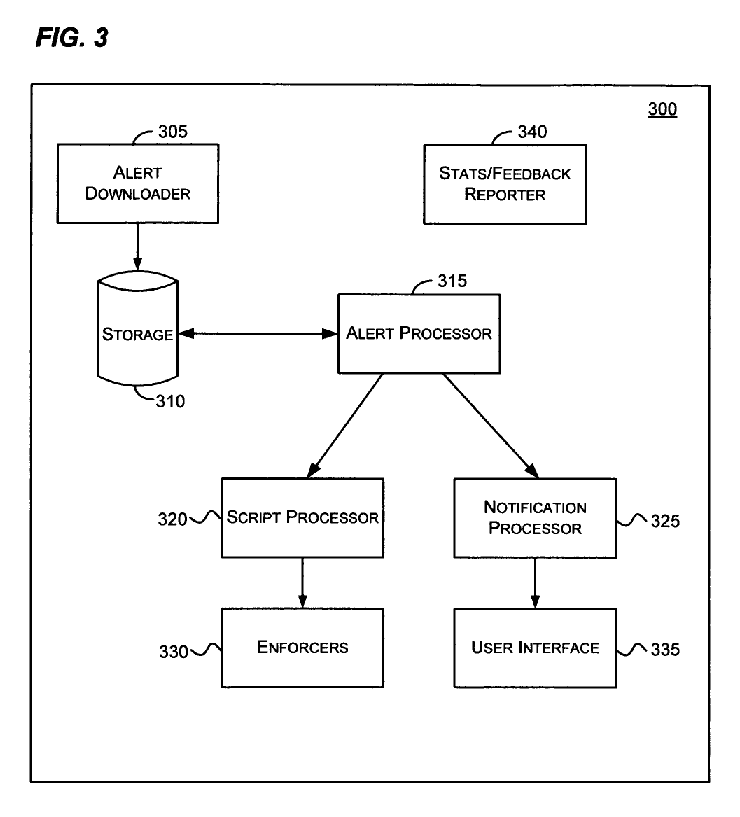

FIG. 3 is a block diagram representing an exemplary arrangement of components of a computer in which the present invention may operate in accordance with various aspects of the invention. The computer 300 includes an alert downloader 305, a storage 310, an alert processor 315, a script processor 320, a notification processor 325, one or more enforcers 330, a user interface 335, and stats/feedback reporter 340 and may also include other components (not shown).

The alert downloader 305 monitors for new alert packages and downloads them when it detects that a new alert package is available. The alert downloader 305 stores each package it downloads into the storage 310. The alert processor 315 obtains an alert package from the storage 310 and splits the package into a message to be displayed via the user interface 335 and a script (if any). When a script is included in an alert package, the script processor 320 evaluates the checks in the script and determines whether the actions associated with the script should be taken. The action script processor may instruct one or more enforcers 330 to take actions based on the script.

The enforcers 330 include security related components and may include, for example, a firewall policy enforcer that enforces firewall policies and takes actions such as blocking a port, an application policy enforcer that takes actions related to applications such as preventing certain application from executing, a system restore enforcer that restore the computer to previous state if installing a new patch has made the system vulnerable to new threats, and the like. The enforcers may be pluggable. That is, if an enforcer exists and is executing on a computer, the enforcer may perform actions that pertain to it based on a script. If an enforcer does not exist or is not executing on a computer, script actions associated with the enforcer are not performed (although other enforcers may perform other actions indicated by the script). Once a vulnerable component is updated (e.g., via a patch), its associated enforcer may remove the temporary policy (e.g., blocking of a port) it used to mitigate the threat.

The notification processor 325 may display text on the user interface 335 based on the message included in the alert package. The message may include a link to additional information hosted on a Web site. A message may be modified by a script if, for example, the message does not apply to the computer in its present configuration, different mitigating steps should be taken in view of the computer's configuration, and the like.

The stats/feedback reporter 340 may provide feedback and stats regarding an alert. Such feedback and stats may include an indication of whether the alert was successfully delivered if the computer was vulnerable to a threat associated with the alert, if a user saw the alert, and if mitigating actions were performed.

If the feedback or stats indicates that the alert was not successfully delivered to a computer, the alert may be resent to the computer. A user of the computer may be informed of the failure and may be able to obtain alerts on demand.

A history of alerts received by a computer may be stored on the computer. A user of the computer may view the history of alerts through a user interface.

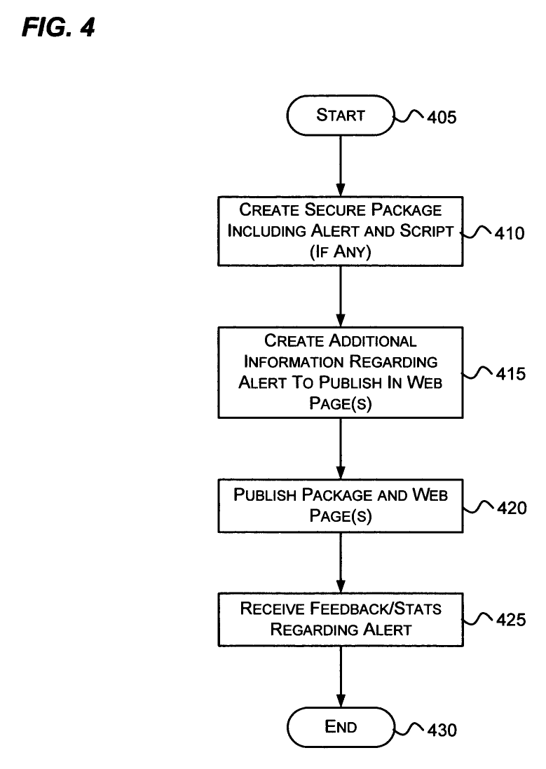

FIG. 4 is a flow diagram that generally represents actions that may occur on an alert publisher in accordance with various aspects of the invention. At block 405, the actions start.

At block 410, a secure alert package is created. The package may include alert text and may also include a script.

At block 415, additional information regarding an alert may be created for publishing on Web page(s). As mentioned previously, the alert text may provide a link to a Web site at which a user may learn more about a particular threat. The actions associated with blocks 415 may be performed before or concurrently with the actions associated with block 410.

At block 420, the package and Web page(s) are published (e.g., made available). Upon subsequent polling of an alert publisher, computers that are monitoring for new alert packages may determine that a new alert package is available and may begin downloading the new alert package.

At block 425, feedback and/or stats are received regarding the alert. Such feedback and stats may include an indication of whether the alert was successfully delivered and to how many computers, the number of users who saw a message regarding the alert, the number of computers which were determined to be affected by the threat, and the number of computers upon which mitigating actions were taken.

At block 430, the actions end.

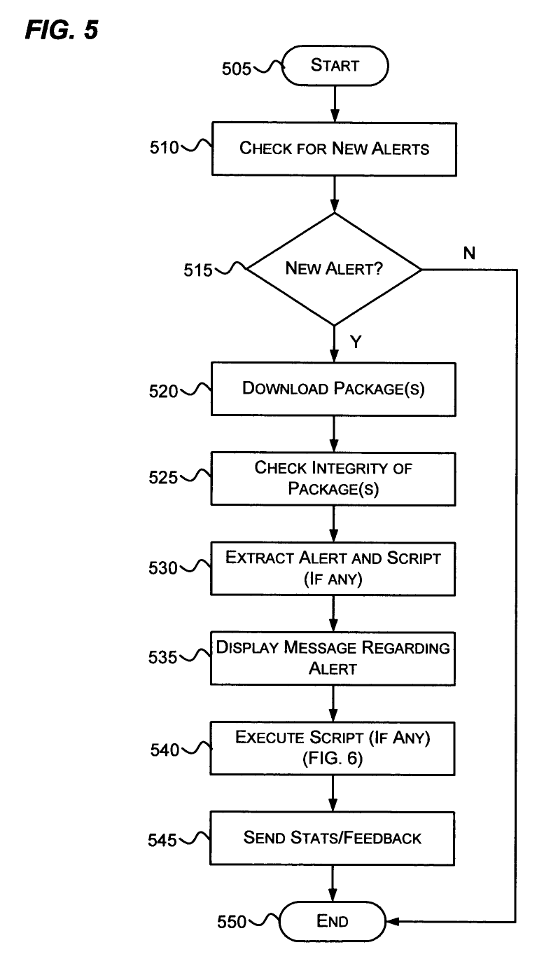

FIG. 5 is a flow diagram that generally represents actions that may occur on a computer that is interested in alerts in accordance with various aspects of the invention. At block 505, the actions begin.

At block 510, a check is made for new alerts. This may be done by polling an alert publisher. In some embodiments, computers are notified when new alerts are available.

At block 515, if a new alert exists, processing branches to block 520; otherwise, processing branches to block 550. At block 520, any new alert packages that are available on the alert publisher are downloaded to the computer that is interested in the alerts.

At block 525, the integrity of the packages is checked. Checking the integrity of a package is done to ensure that the package has not been modified by an unauthorized entity. This may be done via a digital signature with which the package is signed.

At block 530, the alert message is extracted from the package. If the package includes a script, the script is also extracted from the package.

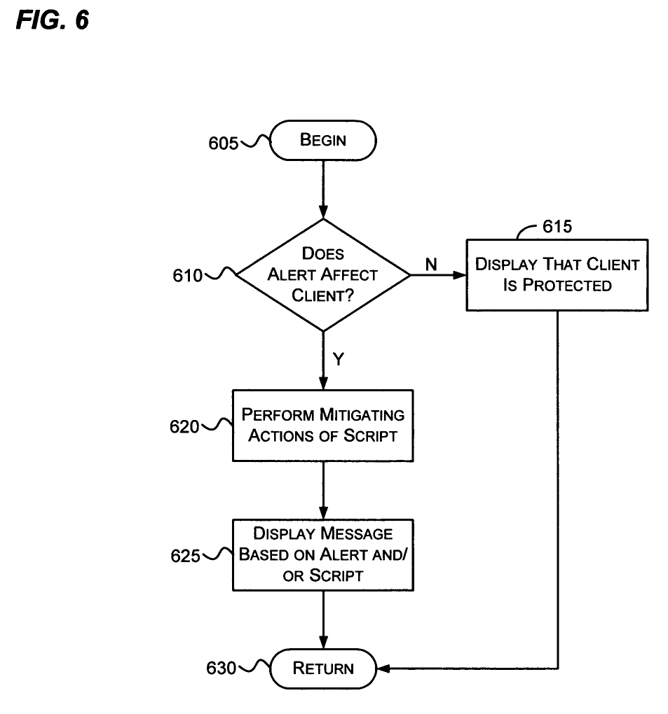

At block 535, the message is displayed. At block 540, the script (if any) is executed as described in more detail in conjunction with FIG. 6. Note that the actions associated with blocks 535 and 540 may occur in parallel or may occur in reverse. That is, the actions associated with block 540 may occur before the actions associated with block 535. This may be done (if a script exists) for example, because the script may change the message that is to be displayed or prevent the message from displaying based on the applicability of the alert to the particular computer.

At block 545, stats and/or feedback are sent regarding the alert. At block 550, the actions end. The actions described above may be repeated each time a computer decides to check for new alerts.

FIG. 6 is a flow diagram that generally represents actions that correspond to block 540 of FIG. 6 that may occur when a script included in an alert package is executed in accordance with various aspects of the invention. At block 605, the process begins.

At block 610, a determination is made as to whether the threat associated with the alert affects the client. If so, processing branches to block 620; otherwise, processing branches to block 615. A threat may not affect a client, for example, if the client has already installed a patch dealing with the threat, if the client has not installed a patch that introduced a vulnerability to the threat, if the client is running a different operating system, and for various other reasons.

At block 615, a message may be displayed that indicates that a threat exists but that the client is not vulnerable to the threat.

At block 620, mitigating actions are performed to mitigate the threat. In some implementations, a user is asked before performing the mitigating actions. In some implementations, a user selects a link associated with the script to have the mitigating actions performed. In yet other implementations, the mitigating actions are performed automatically and without user involvement.

At block 625, a message may be displayed based on the alert and/or the script. The message may indicate what mitigating actions were performed and how the actions will affect the client.

At block 630, the process returns.

FIG. 7 shows a window that includes an exemplary message that may be displayed in response to an alert in accordance with various aspects of the invention. Although not shown, the message may include a link that executes mitigating actions of a script.

Aspects of the invention described herein may, among other things, be used to:

broadcast communication to a set of computers to notify users of an emergency;

broadcast communication to a set of computers to notify users of an emergency and provide instructions or guidance in dealing with the emergency;

broadcast communication to a set of computers to notify users an emergency and provide a script to protect the computers until a patch is developed to deal with the emergency; and

broadcast communication including a script to a set of computers wherein the script determines whether each of the computers is vulnerable to a threat and wherein the script may cause messages to be displayed on each of the computers accordingly.

Below is an exemplary schema and exemplary data therein of an exemplary alert package in accordance with various aspects of the invention:

<?xml version=“1.0” encoding=“utf-8” ?>
<EmergencySecurityAlert>

<SchemaVersion>1071</SchemaVersion>
<SecurityAlert>

<AlertID>{7FFEF952-324C-430e-9817-

0C0FBDAD6CA5}</AlertID>

<PatchIDToDownload>Q282010</PatchIDToDownload>

<ReleasedDateTimeUTC>
2000-01-20T12:00:00Z

</ReleasedDateTimeUTC>
<!-- Expiry date of the alert. If user has not seen the
alert by this time then system will auto dismiss the alert -->
<ExpiryDateTimeUTC>

2000-01-28T12:00:00Z

</ExpiryDateTimeUTC>

<Title LocNeeded=1>Internet Explorer Vulnerability
</Status>
<Description LocNeeded=1>
A new virus XYZ is spreading on the internet
and exploits vulnerability reported in Microsoft
Security Bulletin MS02-050 for Microsoft IE.
Microsoft recommends that you enable your
Firewall using Microsoft Security Center.
</Description>

<MitigationText LocNeeded=1>
Ensure that internet connection firewall is ON and

your virus definitions files are up-to-date.

</MitigationText>
<MoreInformationLink>

<LabelText LocNeeded=1>
Click here to get more information about
this emergency alert and how to use Microsoft Security
Center
</LabelText>
<Link Parameter = LocID>
www.microsoft.com/security/alerts.asp
</Link>

</MoreInformationLink>

</SecurityAlert>
<Actionscripts>
<Script>

<Enforcer>

<Firewall>

<ComponentID>
{7FFEF952-324C-430e-9817-0C0FBDAD6CA5}
</ComponentID>
<Parameter>
<<![CDATA[Firewall policy data]]>
</Parameter>

</Firewall>

</Enforcer>
<EnforcementCondition>

<PatchIDDownloaded ID =

Q282010>FALSE</PatchIDDownloaded>

<LogicOperator>AND </LogicOperator>
<ApplicationInstalled>SQL</ApplicationInstalled>
<InvokeEnforcer>Firewall</ InvokeEnforcer>

</EnforcementCondition>

</ Actionscripts>
</Script>

</EmergencySecurityAlert>

As can be seen from the foregoing detailed description, there is provided a method and system for communicating emergency information about computer security threats and providing mitigating actions that may be performed to address the threats. While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer-readable medium having computer-executable instructions, comprising:
creating a secure package that includes a message regarding a threat and that potentially includes a script that includes actions to mitigate the threat;
publishing the secure package to make the secure package available for downloading; and
transmitting the secure package to a set of computers.

2. The computer-readable medium of claim 1, wherein creating a secure package comprises signing the secure package with a digital signature that enables the set of computers to determine if the secure package has been modified since signing.

3. The computer-readable medium of claim 1, wherein the message includes instructions indicating actions to perform manually to mitigate the threat.

4. The computer-readable medium of claim 1, wherein the message includes a link that indicates where more information regarding the threat is located.

5. The computer-readable medium of claim 1, wherein the message includes a link that, when selected, causes the actions of the script to be performed.

6. The computer-readable medium of claim 1, wherein the actions comprise one or more of blocking a port of a firewall, preventing an application from executing, and restoring a previous state of system upon which the script executed.

7. The computer-readable medium of claim 1, further comprising receiving statistics from the set of computers, wherein the statistics comprise one or more of: a number of the computers vulnerable to the threat, a number of how many of the computers upon which the message was viewed, and a number of the computers upon which mitigating actions were taken.

8. The computer-readable medium of claim 1, wherein the actions are performed automatically and without a prompt asking whether to perform the actions.

9. A method for propagating alerts, comprising:
downloading an alert package that includes a message regarding a threat and that potentially includes a script that includes an action to mitigate the threat; and
extracting the message from the alert package.

10. The method of claim 9, further comprising checking whether a new alert package is available before downloading the alert package.

11. The method of claim 9, further comprising checking the integrity of the alert package to determine whether the alert package was modified after creation.

12. The method of claim 9, further comprising displaying the message together with a link that, when selected, causes more information about the threat to be displayed.

13. The method of claim 9, further comprising displaying the message together with a link that, when selected, causes the action of the script to be performed.

14. The method of claim 9, wherein the alert package is downloaded to a computer, and wherein the script also includes an action that modifies the message based on whether the computer is vulnerable to the threat.

15. The method of claim 9, further comprising modifying the alert package and providing the alert package as modified to a set of computers, wherein the set of computers to which the alert package is provided is based on a policy.

16. The method of claim 9, further comprising providing feedback that comprises one or more of: whether the alert package was successfully downloaded to a computer, if the computer is vulnerable to the threat, if a user of the computer viewed the message, and if the action was performed.

17. An apparatus for propagating alerts, comprising:
an alert downloader arranged to obtain an alert package and store the alert package;
an alert processor arranged to retrieve the alert package from storage, check the integrity of the alert package, and extract a message and potentially a script from the alert package; and
a notification processor arranged to display the message or information derived therefrom.

18. The apparatus of claim 17, further comprising a script processor arranged to evaluate checks in the script to determine whether an action included in the script is performed.

19. The apparatus of claim 18, further comprising an enforcer that performs the action, wherein the enforcer comprises one or more of: a firewall policy enforcer, an application policy enforcer, and a system restore enforcer.

20. The apparatus of claim 17, further comprising a stats/feedback component arranged to provide notification comprising one or more of: whether the alert package was successfully downloaded to a computer, if the computer is vulnerable to the threat, if a user of the computer viewed the message, and if an action included in the script was performed.
